(19) United States
(12) Patent Application Publication
(10) Pub. No.: US 2026/0199972 A1
(43) Pub. Date: Jul. 16, 2026

(54) PROCESS FOR MANUFACTURING A GOLD ALLOY TIMEPIECE COMPONENT, AND RESULTING TIMEPIECE

(71) Applicants: Manufacture d' Horlogerie Audemars Piguet SA, Le Brassus (CH); Norimat SAS, Toulouse (FR)

(72) Inventors: Thibaut Le Loarer, Chavannaz (FR); Lucas Raggi, St-Blaise (CH); Jonathan Bensaid, Drémil-Lafage (FR); Bastien Nodenot, Toulouse (FR); Yannick Beynet, Toulouse (FR)

(73) Assignees: Manufacture d'Horlogerie Audemars Piguet SA, Le Brassus (CH); Norimat SAS, Toulouse (FR)

(21) Appl. No.: 19/142,049

(22) PCT Filed: Dec. 14, 2023
(86) PCT No.: PCT/IB2023/062671

§ 371 Date: Jun. 20, 2025

(30) Foreign Application Priority Data
Dec. 20, 2022 (EP) 22215110.2

(51) Int. Cl. B22F 1/14; B22F 9/08; G04B 37/22

(52) U.S. Cl. CPC B22F 1/14; B22F 9/082; G04B 37/22; B22F 2301/255; B22F 2998/10; B22F 2999/00

(57) ABSTRACT

The present invention relates to a process for manufacturing a timepiece component in which gold alloys are assembled to make mixed powders for producing alloys having specified colors. The powders are combined and arranged to create visual effects on the timepiece component. The invention further relates to a timepiece component and a timepiece comprising at least one of said timepiece components.

### TECHNICAL DOMAIN

This invention relates to a process for the manufacture of a watch component based on several precious or noble metals or alloys of such metals. In particular, at least one of these precious metals or precious metal alloys is gold or one of its alloys. Preferably, the process described here is applied to the manufacture of a watch component based on several different types of gold. The various precious metals, golds, or their alloys are individually atomized into distinct powders and then mixed in predetermined proportions to produce homogeneous mixed powders. The proportions of metals, golds or corresponding alloys constituting a mixed powder are determined according to the color to be obtained on the finished component. The mixed powders are arranged in relation to each other so as to form a colored pattern such as a gradient, and are jointly involved in a sintering operation, in particular SPS (spark plasma sintering) also known as flash sintering. The composites resulting from the different mixed powders can be distinguished from each other in the watch component thus obtained, in particular by their color. The present description also covers a watch component made up of several distinct gold alloys assembled in composites, as well as a timepiece comprising such a component.

### RELATED ART

The principle of sintering metallic material powders is well-known and often used to manufacture metal alloys. Document EP3766997, for example, describes the formation of precious metal alloys using such a process. However, such alloys require that all the powders be mixed to form a single, preferably homogenized, mixture. Such processes do not allow the production of components with local compositions that differ from one another.

Document EP3822712 gives an example of a process based on metal powders for the design of a component for a timepiece comprising a surface fusion stage to eliminate defects.

Document WO2015061817 describes a multiphase structure produced by the intercalation or interpenetration of different materials, in a random, unique and individual arrangement, serving as an element of authentication for a piece of jewellery or a luxury product. The resulting multicolored macrostructure is difficult to reproduce and thus acts as an anti-copying measure.

Document CN110328371A describes a multi-stage process in which different materials are successively placed in a mold and compressed with a characteristic shaped element to produce the desired pattern.

Document CN111992731A describes a process for embedding particles in gold to increase its hardness.

The sintering technique is an alternative to brazing or welding that has the advantage of limiting or avoiding the addition of material at the interfaces, as well as the mixing of the materials present. There is therefore scope for developing a process specifically adapted to precious materials, in particular gold alloys, allowing for a greater variety of their use and assembly.

Moreover, in the field of watchmaking, the aesthetic properties of the alloys used are sometimes of crucial importance, in that they determine the appearance of the final piece. The commercially available alloys may have aesthetic variations between them, but their color is not adjustable, which limits the diversity of colors and appearances that can be obtained. Mastery of color nuances remains a challenge today. It is therefore necessary to develop processes that make it possible to produce materials on demand according to their aesthetic properties, and in particular their colors.

### Short Disclosure of the Invention

One aim of the present invention is to propose a method of manufacturing a watch part and/or a timepiece that allows for greater aesthetic diversity, particularly in terms of shades, colors, tints and their combinations.

Another aim of the present invention is to propose a process for manufacturing a watch component and/or a timepiece that makes it possible to determine its composition according to the colors, tints and shades expected in the final part.

Another purpose of the present invention is to propose a method of manufacturing a watch component and/or a timepiece whose decorative motifs, obtained by means of the components of the watch component and/or the timepiece, are reproducible.

Another aim of the present invention is to propose a method of manufacturing a watch component and/or a timepiece whose decorative motifs are obtained in the mass, the structure of the watch component and/or timepiece remaining homogeneous.

Another aim of the invention is to offer a watch element and/or a timepiece of higher quality and/or aesthetic diversity, particularly in terms of shades, colors, tints and their combinations.

Another purpose of the present invention is to propose a watch element and/or a timepiece comprising decorative motifs obtained in the mass and whose shapes and colors are reproducible from one piece to another, and forming a homogeneous structure.

According to the invention, these goals, or at least some of these goals, are achieved, in particular by means of the process, the watch element and the timepiece that are the subject of the independent claims and detailed in the dependent claims.

This solution has the particular advantage over the prior art of being able to predetermine the compositions of the elements and timepieces according to the colors and/or final shades to be obtained, in a greater diversity than that currently available. This solution also allows for a high degree of reproducibility of the shapes and colors of the decorative motifs, while preserving a homogeneous structure of such timepieces.

### SHORT DESCRIPTION OF THE DRAWINGS

Examples of the implementation of the invention are indicated in the description illustrated by the following figures:

FIG. 1: example of a colorimetric curve for some gold alloys according to the present invention

FIG. 2: example of a colorimetric curve as a function of the mass percentage of 5N gold

FIG. 3: example of the distribution of different gold alloys in a rough sketch for a timepiece, according to the present description

FIG. 4: example of colorimetric analysis model used in the present process

### EXAMPLES OF EMBODIMENTS OF THE PRESENT INVENTION

The process according to the present description makes it possible to obtain a watch component, as well as a timepiece comprising such a component, in which several colored shades are juxtaposed, thus making it possible to produce a wide variety of patterns. The colors or shades are directly related to the material constituting the watch element and are not limited to surface coloring. The process according to the present invention makes it possible to arrange various precious materials, in particular several gold alloys, without mixing them. The process according to the present description also makes it possible to obtain a greater diversity of combinations, compared to the predetermined alloys already available on the market. The composites produced according to the process described here may have different mechanical characteristics from one another, particularly in terms of hardness. The composites produced according to this process also have specific aesthetic characteristics, which are exploited as a priority in the context of this invention.

For the purposes of this description, the term “composite” refers to a material resulting from the sintering of the mixed powders described here under the conditions of this process. As the process does not involve the fusion of these powders, the resulting composites are not considered to be alloys. Preferably, the different powders are each produced from a precious metal, in particular gold, or their alloys. The powders can be described as “mixed”. Preferably, the mixed powders include at least one gold.

In one embodiment, the watch elements considered here are produced on the basis of at least one composite, which can be combined with at least one other material such as a composite, pure gold and/or an alloy, for example a gold alloy. Such another material is referred to in this description as a separate material. In such an arrangement, the composite remains distinct from the distinct materials in the final product. The process of the present invention makes it possible to produce the composite, preferably an assortment of several composites, and to assemble them. It includes in particular a first selection step S1 of a first gold O1 in the form of a first powder P1 and a second material in the form of a second powder P2. According to a preferred aspect, the second material refers to a second gold O2.

For the purposes of this description, a “gold”, such as a first gold and a second gold, can refer to pure gold or any gold-based alloy already available on the market. A gold can therefore refer to an alloy of white gold, or rose gold, or grey gold, or green gold, or red gold. Preferably, gold as described herein refers to a material comprising at least 37.5% (9 ct), or even at least 75% (18 ct) or more, 92% (22 ct) or even 100% (24 ct) %. Preferably gold as described herein refers to an alloy of 18 carats or more, such as 18 or 24 carats. Gold as described herein may include elements other than gold, such as precious or noble metals, including silver (Ag), platinum (Pt), palladium (Pd), rhodium (Rh), scandium (Sc), ruthenium (Ru) osmium (Os) and iridium (Ir), non precious metals including copper (Cu), titanium (Ti), tin (Sn), nickel (Ni), aluminum (Al) or combinations thereof. Precious and non-precious metals can be used independently of each other in various grades, such as 9 ct, 12 ct, 18 ct or 24 ct, or in other grades. The gold grades mentioned here refer to all gold grades from 1N to 5N. Non-exhaustive examples of gold and its composition are defined below:
White gold: 75% gold, 19% copper, 6% silver,
White gold: 75% gold, 25% palladium or 25% nickel,
Red gold: 75% gold, 25% copper,
Pink gold: 75% gold, 20% copper, 5% silver,
Green gold: 75% gold, 25% silver.

One or more additional materials Mi, different from the first gold O1 and the second material, can be selected in this selection step S1. The additional materials can be independently selected from the precious or noble materials and/or the non-precious materials mentioned above. The additional material(s) Mi are in the form of as many corresponding additional powders Pi.

The process comprises a first stage of mixing S2 the first P1 and second P2 powders, and if applicable the additional powder(s) Pi, so as to produce a first homogeneous mixed powder PM1.

The first gold O1, the second material, as well as any additional materials, are selected according to their nature, that is to say, their composition, and are mixed in predetermined proportions, as explained in more detail below. In this case, the compositions and proportions of the different golds, determined by their mass percentage, are predetermined according to the expected final color of the timepiece.

A watch component may comprise only one composite. In such circumstances, this timepiece component will have a uniform color representative of the composite, which may be different from the usual colors representative of commercial alloys.

According to a more advantageous embodiment, a watch component comprises a composite combined with another material. For this purpose, the process makes it possible to combine the first mixed powder PM1 with other powders already available on the market. For example, a distinct material Md in powder form Pd can be arranged together with the first mixed powder PM1 so that the color Cd of the distinct material Md differs from the color C1 of the composite A1 resulting from the first mixed powder PM1. In this case, the color Cd will correspond to an already existing color and the color C1 will be characteristic of the composition of the mixed powder PM1.

According to another embodiment, a timepiece component comprises two or more combined composites. For this purpose, the process comprises at least one other selection step and one other mixing step as described above, and possibly the addition of additional materials, such as to produce at least one composite of a different color from that of the composite resulting from the first selection step S1 and the first mixing step S2. The resulting mixed powder(s) are not limited in number or color. For example, all shades between white gold and rose gold can be obtained by as many mixed powders.

Thus, the process according to the present description could include at least a second selection step S1′ of a second first gold O1′ and at least a second second material in the form of a second first P1′ and at least a second second P2′ powder respectively, and one or more possible second additional materials Mi′ in the form of as many additional second powders Pi′. In an advantageous arrangement, the second second material refers to a second second gold O2′. The process also comprises at least a second mixing step S2′ of said second first P1′ and second P2′ powders and, if applicable, one or more additional second powders Pi′, so as to produce at least a second mixed powder PM2.

It is understood that more than two different golds can be selected and mixed as needed, in particular to obtain very specific shades. For example, white, pink and red golds can be mixed, or pink, green and gray golds, etc. Furthermore, the mixing of two or more golds does not exclude their mixing with one or more second materials, nor with one or more additional Mi materials.

Other selection stages and mixtures of different golds can be carried out to produce as many different mixed powders MPi as will then be used in the manufacture of the timepiece. The number of mixed powders is not limited. A timepiece can be made using two, three, four, five or more different mixed powders. In addition, separate materials in powder form can be used in combination with the mixed powders, as indicated above, which may not contain gold.

In the context of this description, a mixed powder refers to a homogeneous powder comprising at least two materials. Preferably, a mixed powder refers to a homogeneous powder comprising at least one gold, combined with at least one other material such as a precious metal or an alloy. Preferably, a mixed powder according to the present description refers to a homogeneous powder comprising at least two different golds. A homogeneous powder means that the different constituents are distributed uniformly, i.e. without a concentration gradient. In this way, the color of the mixed powder is uniform. In addition, a homogeneous powder is defined by a predetermined and constant particle size where, for example, more than 80%, or more than 90%, or more than 95% of the particles have a size corresponding to a reference size. The particles are, for example, micrometric in size, i.e. with an average diameter of around 1 μm to 500 μm, or preferably 10 to 100 μm. Alternatively, the particles may be sub-micrometric, i.e. with an average diameter of less than one micrometer. The average particle size of mixed powders can be adjusted according to the material in question and/or the result to be obtained.

The term “homogeneous” excludes multiphase or polyphase structures comprising, for example, inclusions within a matrix, resulting in heterogeneous mixtures. The term “homogeneous” is synonymous here with monophase or single-phase. The term “homogeneous” applies to all mixed powders, composites and additional materials, as well as to their combination.

For the purposes of this description, a “homogeneous structure” refers to the material resulting from the process described herein, based on one or more powders according to the present invention, whether they are juxtaposed or mixed. Although they may have different optical or physical properties, the juxtaposed powders result in a structurally homogeneous material, particularly with regard to its particle size. In particular, a homogeneous structure excludes any inclusion of a particle size greater than 5%, 10% or 20% of the average particle size of the powders used in its composition. A homogeneous structure is synonymous here with a monophasic or single-phase structure.

The process includes a step S3 of placing in a mold the powders obtained separately, regardless of their number, including at least one mixed powder PMi. The process thus includes a step S3 of placing the first mixed powder PM1 and at least a second powder. The at least a second powder can be a powder Pd of a distinct material Md. The distinct material Md can be chosen from pure metals, in particular pure gold or a precious metal, or gold alloys, or alloys of precious metals not containing gold. Alternatively or in addition, the at least one second powder can be a second mixed powder PM2. The second mixed powder contains at least one gold. In this way, a combination of at least two powders can be formed in which at least one of the powders consists of a mixed powder as described above. It is understood that the mixed powders and the separate material powders all remain distinct from each other and are not mixed during the process. In other words, the different powders are juxtaposed, contiguous or superimposed, so as to retain their properties, and in particular their characteristic color. Preferably, the different powders are brought into contact with each other, which makes it possible to produce colored patterns such as gradients or designs or visual effects such as camouflage or other patterns. This does not exclude the possibility that the different powders may be separated from one another by a partition, such as a metal partition producing a pattern in itself. The powders are preferably arranged sequentially so as not to mix. They can each be arranged to form a bed of powder, or a pile of powder, or in different arrangements such as in the form of lines, or geometric figures, or appearing random, although reproducible. Depending on the requirements, one or more of the mixed powders can be used several times, for example to form several piles, or several lines, or on several layers alternating with other powders.

It is understood that two juxtaposed powders are selected so that their expected colors at the end of the process differ from each other.

The mold used is suitable for sintering the powders placed in it. In particular, the mold is suitable for flash sintering or SPS (spark plasma sintering). The use of electrodes to heat the assembly of unmixed powders allows for very short heating times and preserves the fineness of the grains.

Depending on the method used, the powders may be subjected to vibrations or any other process to make them denser or distribute them more evenly if necessary. It is therefore important to ensure that the mixed powders do not mix during these processes, if they take place.

The mixed powders are arranged in relation to each other according to the colored patterns to be obtained. In other words, a positioning plan for the mixed powders can be drawn up, which makes it possible to arrange the powders, identified by their colorimetric characteristics, at predetermined locations and in predetermined spaces in the mold. The resulting patterns are thus reproducible.

The process includes a step S4 of performing solid-phase sintering under conditions that make it possible to produce a solid part from the assembly of powders placed in the mold. The sintering is preferably flash or SPS sintering carried out at a sintering temperature Tfri and a sintering pressure Pfri determined such that none of the powders, and in particular none of the mixed powders, melt. For example, the melting temperature of gold at atmospheric pressure is approximately 1064° C. The melting temperatures of gold alloys are generally higher than this value. The sintering pressure Pfri can in this case be a mechanical pressure. Preferably, the sintering temperature Tfri is determined so as to remain below the lowest of the melting temperatures of the mixed powders PMi under sintering conditions. The appropriate sintering temperature Tfri can be evaluated as a function of the sintering pressure Pfri, so as not to reach or exceed, or to remain below, the melting temperatures of the mixed powders at the sintering pressure Pfri. The temperatures are also adjusted so as not to degrade any structural elements incorporated in the powders, such as separating elements.

In one embodiment, the sintering temperature Tfri is less than 2000° C., or even less than 1500° C., or even less than 1000° C. The sintering temperature is, for example, between 600° C. and 1600° C.

The sintering pressure Pfri can be between 20 and 180 N/mm² or between 50 and 100 N/mm². Other pressure values may be preferred depending on the components selected and/or the required quality of the final mechanical part.

After sintering, the mixed PMi powders lead to as many gold composites Ai. For example, the first mixed powder PM1 leads to a first gold composite A1, the second mixed powder PM2 leads to a second gold composite A2, etc.

The piece resulting from sintering is a single piece comprising several distinct materials bonded together. The materials can be independently selected from gold alloys, pure gold and mixed powders such as those described above. The part therefore has different compositions in different places. According to one embodiment, the part comprises at least one composite made from a mixed powder as described above. As they are produced in different colors, the mixed powders give the resulting part as many different colors as there are colors in the composites used.

The process includes a stage S5 of removing the solid part from the mold to obtain a demolded part, typically a pellet, a preform or a rough sketch. The solid part removed from the mold may correspond to the final component. However, the part removed from the mold may require one or more subsequent operations to improve its quality or aesthetic appearance or to modify its shape to obtain the final component 1. A grinding step S6 may, for example, allow the solid part removed from the mold to be resized. A machining stage S7 can be carried out conventionally to modify the solid part by any suitable technique, whether mechanical, laser, water jet or any equivalent. One or more finishing steps S8 may also be envisaged. Other post-sintering transformations can be provided as required.

Alternatively or in addition, the solid part removed from the mold may be finished by one or more decorative operations such as satin finishing, beading, mirror polishing or glass bead blasting, locally or over its entire surface.

The nature of the first gold O1, of the second material, in particular of the second gold O2 and of any additional materials Mi, as well as their proportions in the corresponding mixtures, are determined so that the resulting mixed powder PM1 produces a first composite A1 of color C1 under the conditions of the process. The first color C1 is not necessarily identical to that of the corresponding mixed powder PM1 before the sintering operation. It can also be difficult to precisely characterize the color of the mixed powder before sintering. It must therefore be ensured that during the process, the mixed powders produced upstream lead to the corresponding composites Ai with the appropriate color. The nature of the at least one second first O1′ and second O2′ golds and any second additional materials Mi′, as well as their proportions in the mixture, are also determined so that the resulting mixed powder or powders PM2 produce a second composite A2—or several other composites Ai, of color C2 and Ci respectively, under the conditions of the process. The second color C2 is different from the first color C1. The other colors Ci are also different.

The various Ai composites are each developed and produced so as to have a Ci color corresponding to a predetermined color. The various Ai composites represent gold composites combining at least one gold and another material. The gold can be selected, for example, from pure gold, white gold alloys, rose gold alloys, grey gold alloys, green gold alloys, yellow gold alloys, blue gold alloys, purple gold alloys and red gold alloys. Typically, the other material refers to a precious metal or a precious metal alloy. It can also refer to non-precious metals and their alloys. Preferably, the various Ai composites represent gold composites combining at least two golds. The two golds can be independently selected from those mentioned above or others. In this context, the present description covers a means of determining the composition of these Ai composites as a function of the colors to be obtained on the finished part. The process described herein may include one or more Se calibration steps consisting of selecting and mixing at least one gold and a second material as described in steps S1 and S2 above, for example, so as to constitute a mixed powder, and determining the visual characteristics thereof. The visual characteristics are determined in particular after a sintering operation representative of the conditions applied to the manufacture of the part. The visual characteristics of a mixed powder can be determined by any means in force, such as colorimetric tests.

According to one embodiment, a colorimetric test can be based on a chromatic space of the L*a*b* type, where L* designates lightness and can take values from 0 to 100, where a* designates the axis going from green to red, and where b* designates the axis going from blue to yellow. FIG. 4 shows an example of such a chromatic space used to characterize the colors of the resulting pieces. However, other characterization systems can be used.

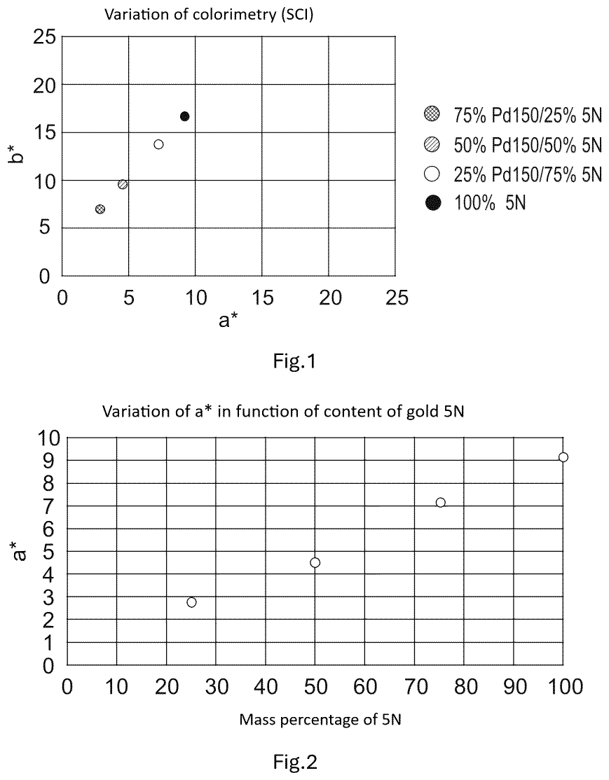

A Se1 standardization step according to the present description may consist of producing several mixed powders comprising a given gold and a second material, or two specific golds, in varying proportions, to involve them in a sintering operation such as that described above, so that the mixed powders produce the corresponding composites, and after removal from the mold to characterize their colors. FIG. 1 gives an example of such a calibration curve of the a* and b* values of the following composites:
75% Pd150/25% 5N18
50% Pd150/50% 5N18
25% Pd150/75% 5N18
100% 5N18
   where the term 5N denotes a 5N red gold alloy and Pd150 denotes a nickel-free 18 ct white gold alloy, both alloys being marketed by the PX Group company. A composite material used for the manufacture of a watch element or a timepiece may correspond to one of these compositions or to an intermediate composition depending on the targeted color.

Several similar curves can be developed on the basis of several other golds. In addition, other parameters than a* and b* can be determined. In particular, the parameters L*, a* and b* can be determined either individually or in binary combination in a two-dimensional space, or all together in a three-dimensional space.

According to one embodiment, a Se2 calibration step may consist of producing several mixed powders each comprising a mass percentage of a variable element, involving them in a sintering operation such as that described above, and after demolding, characterizing one or more of the L*, a*, or b* parameters. In this way, the influence of one of the golds on one or other of the parameters L*, a* and b* can be precisely determined. FIG. 2 gives an example of such a calibration curve, making it possible to determine the influence of 5N gold on the a* parameter.

The nature and proportions of the gold alloys mixed in each of the mixed powders can thus be determined on the basis of one or more calibration curves such as those developed during either of the calibration stages Se1 and Se2 described above. Depending on the method used, extrapolation or interpolation of the calibration points makes it possible to determine the nature and/or proportions of the gold to be mixed in order to obtain an alloy of a predetermined color. Depending on the method used, a computer-implemented predictive model may be used. In this case, the final colors of a piece to be produced can be selected on an appropriate graphic interface. The model then makes it possible to determine the compositions of the corresponding mixed powders. Depending on the method of implementation, other parameters may also be proposed by the program, such as the temperature and pressure conditions of the sintering operation. In other variants, input values other than colors can be implemented in the program. For example, hardness or density properties can be the subject of a secondary selection and allow the colors to be adapted to other physical constraints such as resistance to friction and scratching.

The Se1 and Se2 calibration stages described above may be based on materials other than gold, in particular the additional Mi materials that may be used in the design of the PMi mixed powders.

The calibration stage(s) are preferably carried out prior to the selection S1 and/or mixing S2 steps of the powders, on calibration pieces produced according to the process described here. In this way, the composition of the powders can be determined according to the colors to be obtained at the end of the process, thus avoiding the multiple trials and errors needed to obtain a piece of the required color.

Additives may also be included in the composition of mixed powders. Such additives may include metal oxides or pigments, which may also be the subject of calibration curves.

According to a preferred embodiment, the mixed powders produced according to the process described herein do not include any pigment. Preferably, the mixed powders consist exclusively of a mixture of two or more golds. Alternatively, the mixed powders according to the present process consist exclusively of a mixture composed of at least two golds, a precious or noble metal and/or a non-precious metal such as those mentioned above or their alloys. Alternatively, mixed powders according to the present process consist of, or are exclusively composed of, two or more golds and a precious or noble metal. Alternatively or additionally, mixed powders according to the present process do not include more than one pure gold.

The golds involved in the present process can be acquired in the form of powders. Alternatively, the process according to the present description includes one or more gold atomization steps. For example, the process may include a step S1a of atomizing the first gold O1 so as to produce said first powder P1. It may also include a step S1b of atomizing said second material, for example a second gold O2 independently of the first gold, so as to produce said second powder P2. Alternatively or additionally, it may include a step Si of atomizing additional materials, if any, so as to produce the corresponding powder(s) Pi. The same atomization steps can be reproduced for one or more of the other powders. In particular, the process may include an atomization step S1a′ of the second first gold O1′ so as to produce the second first powder P1′, an atomization step S1b′ atomization step of the second second material, for example a second second gold O2′ so as to produce the second second powder P2′ and/or an atomization step S1i′ of any second additional materials Mi′ so as to produce the corresponding powder(s) Pi′. Preferably, the atomization steps S1a, Sa′ etc. make it possible to control the properties of the powders obtained, in particular their granulometry, particle size distribution, etc. The atomization conditions may be identical for all powders or vary according to the materials used or the results to be obtained.

The process according to the present description may also include one or more subsequent steps of transformation of the solid part removed from the mold. For example, it may include a step S6 of rectification of the solid part removed from the mold to the desired thicknesses, a step S7 of machining, and/or a step S8 of finishing the solid part removed from the mold. Alternatively or in addition, the process described here may include one or more steps among operations such as satin finishing, circular graining, mirror polishing or glass bead blasting, depending on the properties of the timepiece to be obtained.

This description also covers a watch component resulting from the process described herein. In particular, this description covers a watch component comprising at least one gold-based composite A1, composed of a first gold O1, and at least one other material, such as a second gold O2, and one or more possible additional materials Mi, Mi′, forming an inseparable whole. Typically, the present description covers a watch component comprising at least two gold-based composites A1, A2, each composed of a first gold O1, O1′ and at least one other material, such as a second gold O2, O2′, and one or more possible additional materials Mi, Mi′, forming an inseparable whole. The watch component is characterized by the fact that the gold-based composites remain distinct from each other and that they have colors C1, C2 distinct from each other. In particular, the colors of the composites A1, A2 or at least of some of the composites used, are different from the usual colors obtained by standard alloys. Preferably, a timepiece according to the present description comprises three, four or more different A1, A2 composites, specifically designed for their color. The timepiece component is further characterized by the fact that the composite(s) remain distinct from any distinct materials they contain.

A watch component can refer to any element used in the composition of a timepiece. A watch component can, for example, refer to a whatchcase, a bezel, a case back, a crown, a winding rotor or parts of a watch strap such as studs, links, pins or a clasp. Other watch components, particularly components that form part of the movement, can be produced in accordance with the terms set out here.

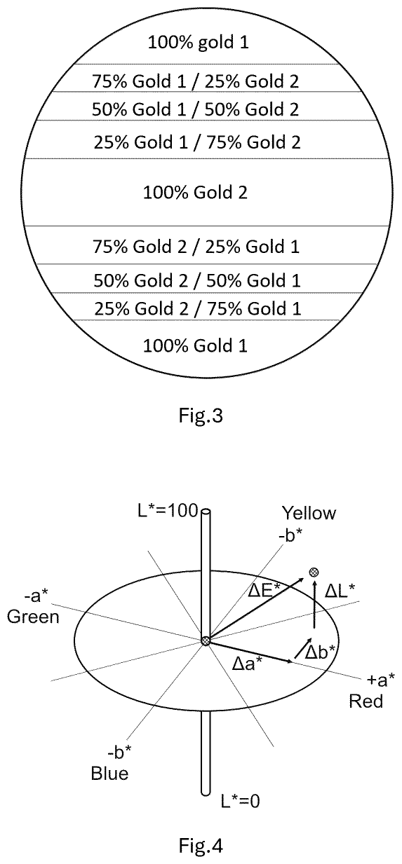

FIG. 3 illustrates an example of a watch component rough sketch comprising several composites A1, A2. In this case, the rough sketch shown in FIG. 3 has a first central alloy symmetrically flanked by a succession of several different composites, thus producing a gradation of colors or tints from the center to the periphery of the component. Two types of gold are represented here, with mass proportions varying from 100% of one type of gold to 100% of the other. Other arrangements are nevertheless possible. According to another method of realization, the different composites can be arranged in the form of concentric circles rather than bands. They can alternatively be arranged in a way that could appear random, although reproducible, so as to create a specific visual effect. In the present case, a central alloy is represented, but it can be replaced by pure gold, or another pure metal, precious or non-precious.

The composites A1 and A2 obtained according to the process described here can be combined with standard alloys. In other words, the watch element can comprise one or more composites resulting from the mixed powders described here, assembled or combined with one or more standard alloys available on the market.

This description also covers a timepiece, such as a wristwatch, comprising at least one watch component as described herein. Preferably, the timepiece is designed so that the watch component is visible to the user. The visual effects may appear on a decorative element, such as the case or part of it, or on other elements that make up or are part of the timepiece, such as movement parts. In addition, the visual effects may be reproduced on several components of the same timepiece, thus producing an enhanced aesthetic effect. For example, the links or part of the links of the bracelet can reproduce the visual effects of the case or another component. Alternatively or in addition, different components of the timepiece may have a solid color resulting from one of the mixed powders produced according to the process described here, so that the different components have a color distinct from each other. It is understood that the variety of different arrangements is not limited and that the present invention offers many possibilities.

### Examples 1

Different white (W) and rose (R) gold alloys are produced and characterized by colorimetry according to the parameters L*, a* and b*:

Atomization of a white gold alloy (W) with the following composition: Au750 PdCu150

Atomization of a rose gold alloy (R) with the following composition: Au750 Ag45 Cu205

The white (B) and rose (R) gold alloys in powder form are weighed and mixed in the turbula. The different compositions obtained are referenced from A1 to A5:

mass % of alloys (B) and (R)

| | | | | | |
|---|---|---|---|---|---|
| Alloy B | 100 | 75 | 50 | 25 | 0 |
| Alloy R | 0 | 25 | 50 | 75 | 100 |
| Reference | A1 | A2 | A3 | A4 | A5 |

Pellets are formed by sintering compositions A1, A2, A3, A4 and A5. The sintering is SPS (Spark Plasma Sintering) with the following characteristics:
pressure force between 5 MPa and 200 MPa
sintering temperature between 300° C. and 1200° C.
sintering time between 10 min and 2 h.

The pellets obtained are then removed from the mold and the colorimetric parameters L*, a* and b* are determined (table 1).

TABLE 1

| | Coordinates L*, a*, b* | | |
|---|---|---|---|
| | L* | a* | b* |
| A1 | | | |
| A2 | 76.07 | 2.46 | 4.48 |
| A3 | 78.71 | 4.48 | 9.53 |
| A4 | 80.53 | 7.14 | 13.75 |
| A5 | 84.48 | 9.14 | 16.63 |

FIG. 1 shows that the evolution of the colors is proportional to the concentrations of the two alloys A and R. FIG. 2 shows the evolution of the a* coordinate as a function of the mass percentage in 5N gold.

The resulting piece is 18 carat

### Example 2

Atomization of a white gold alloy (C) of 22 carats and a composition of: Au925 Pd75

Atomization of a rose gold alloy (D) of 22 carats and a composition of: Au917 Cu83

The white (C) and rose (D) gold alloys in powder form are weighed and mixed in the turbula. The composition obtained is referred to as A6 (table 2):

TABLE 2

| | Mass % |
|---|---|
| Alloy C | 67 |
| alloy D | 33 |
| Reference | A6 |

A pellet is formed by sintering composition A6. The sintering is SPS (Spark Plasma Sintering) with the following characteristics:
pressure force between 5 MPa and 200 MPa
sintering temperature between 250° C. and 1300° C.
sintering time between 10 minutes and 2 hours

The pellet obtained in this way is removed from the mold. The piece obtained is 22 carats.

### Example 3

Atomization of a white gold alloy (A) of 18 carats and composition: Au750 PdCu150

Atomization of a rose gold alloy (D) of 22 carats and composition: Au917 Cu83

Atomization of a non-precious grade 5 titanium alloy (E) of composition: Ti6Al4V.

The white (A) and rose (D) gold and titanium (E) alloys in powder form are weighed and mixed in the turbula. The composition obtained is referred to as A7 (table 3):

TABLE 3

| | mass % |
|---|---|
| Alloy A | 45 |
| Alloy D | 45 |
| Alloy E | 10 |
| Reference | A7 |

The quantities of alloys (A), (D) and (E) must comply with the following equation (E1):

$$VmA \times \% A + VmD \times \% D + VmE \times \% E \geq 75 \% \qquad ( E 1 )$$

where VmA, VmD and VmE refer respectively to the mass percentages of precious materials in alloys A, D and E, and where % A, % D and % E refer respectively to the mass percentages of alloys A, D and E in the piece.

In this way, the final piece is 18 carat.

A pellet is formed by sintering composition A6. The sintering is SPS (Spark Plasma Sintering) with the following characteristics:
pressure force between 5 MPa and 200 MPa
sintering temperature between 350° C. and 1400° C.
Sintering time between 10 minutes and 2 hours

The resulting pellet is removed from the mold. The resulting piece is an 18-carat gold/titanium composite.

In each of the above examples, the removed pellet can be machined by any conventional means such as milling on a 5-axis machine. A timepiece part such as a winding weight, a case, a bezel, a back, a crown, or bracelet elements such as studs, links, pins or a clasp can be obtained. The resulting part can be decorated by one or more satin-finishing, beading, mirror polishing or glass-beading operations.

The process for manufacturing a watch component (1) based on at least one composite including a composite of 18 carats or more according to the present description can be characterized by one or more of the following elements.

It includes an initial S1 selection stage of at least one first gold (O1) in the form of a first powder (P1), a second material in the form of a second powder (P2) and optionally one or more additional materials (Mi) different from the first gold (O1) and the second material, in the form of as many corresponding additional powders (Pi),
a first step of mixing S2 of the said first (P1), second (P2) powders and, where applicable, the additional powder or powders (Pi) in predetermined proportions so as to produce a first homogeneous mixed powder (PM1),
at least one selection stap of a distinct material (Md) in the form of one or more powders (Pd), intended to be combined with the said first mixed powder (PM1) without mixing with it.
a step S3 of placing in a mold (2) said first mixed powder (PM1) and said one or more powders (Pd) of distinct materials (Md), so as to form an assembly of at least two powders, in which said powders are unmixed with one another,
a step S4 of carrying out sintering, the sintering being flash or SPS sintering carried out at a sintering temperature (Tsini) and a sintering pressure (Psini) determined such that neither of the powders (PM1, Pd) melts,
a step S5 of removing the piece resulting from the S4 sintering step to obtain a demolded piece,

The nature of the first gold (O1) and of the second material and of any one or more additional materials (Mi) and/or the proportions of their mixture can be determined so that the said first mixed powder (PM1) is suitable for producing a first composite (A1) of color (C1) under the conditions of the process, and in that the distinct material (Ad) results in a color (Cd) under the conditions of the process, such that the color (C1) of the first composite differs from the color (Cd) of the distinct material (Ad).

The second material may be a second gold (O2), a precious metal other than gold, or a precious metal alloy not containing gold.

The distinct material (Md) designating a precious metal, an alloy of precious metals or a mixed powder suitable for producing a composite under the conditions of the said process.

The distinct material (Md) can be a second mixed powder (PM2) comprising at least one gold. The selection of one or more distinct materials (Md) involves a second selection step S1′ of a second first gold (O1′) and at least one second second material in the form of a second first (P1′) and at least one second second (P2′) powder respectively and one or more possible second additional materials (Mi′) in the form of as many second additional powders (Pi′) and at least one second mixing stage S2′ of the second first (P1′) and at least one second (P2′) powder and, if applicable, one or more second additional powders (Pi′), so as to produce at least a second mixed powder (PM2), where the nature of the second first gold (O1′) and second second materials and any additional second materials (Mi′) and/or the proportions of their mixture are determined so that said at least second mixed powder (PM2) is suitable for producing a second composite (A2) of color (C2), different from (C1) under the conditions of the process.

The second second material designating a second second gold (O2′), a precious metal other than gold or an alloy of precious metals not containing gold.

An “gold” refers to pure gold or a gold alloy.

Additional materials (Mi, Mi′) can be selected from silver (Ag), platinum (Pt), palladium (Pd), osmium (Os), titanium (Ti), nickel (Ni), copper (Cu), aluminum (A1) and their alloys.

The first (P1), second (P2), second first (P1′), second second (P2′) powders are 18-carat or 22-carat.

The first mixed powder (PM1) and the one or more powders of distinct materials (Md) are arranged in step S3 so as to independently form one or more clusters, one or more lines, or several alternating layers.

The sintering temperature (Ts) is between 600° C. and 1600° C.

The sintering pressure (Ps) is a mechanical pressure of between 20 and 180 N/mm².

The process may also comprise one or more steps including a step S1a of atomizing said first gold (O1) so as to produce said first powder (P1), a step S1b of atomization of said second material so as to produce said second powder (P2) and an atomization step S1i of said additional materials so as to produce the corresponding powder(s) (Pi), a step S1a′ of atomization of said second first gold (O1′) so as to produce the second first powder (P1′), a step S1b′ of atomizing said second second material so as to produce the second second powder (P2′) and a step S1i′ of atomizing any additional second materials (Mi′) so as to produce the powder (Pi′).

The process may also include one or more of the following steps: S6: rectification of the solid part removed from the mold to the desired thicknesses, S7 machining of the solid part removed from the mold, S8 finishing of the solid part removed from the mold, S9 decoration comprising one or more operations of satin finishing, circular graining, mirror polishing or glass bead blasting, so as to obtain the said watch component.

The first color (C1) can be determined on the basis of at least one calibration curve developed during at least one previous calibration step Se.

A calibration curve according to the present process makes it possible to determine the proportions of gold, second material and any additional materials and/or their mass percentage in the mixed powders, depending on the color (C1) to be obtained, via extrapolation or interpolation of the parameters measured on the said at least one calibration curve and/or via a predictive computer program.

The watch component according to the present description can be characterized by one or more of the following elements. It may comprise at least one composite, comprising a first gold (O1, O1′) and at least one second material as well as one or more possible additional materials (Mi, Mi′), forming an inseparable whole, and one or more distinct materials (Md) in which the said at least one composite and the one or more distinct materials (Md) remain distinct from each other, the said at least one composite having a color (C1) distinct from the said one or more distinct materials (Md), such that their juxtaposition produces a visual effect, such as a gradation of colors or tints.

The at least one second material may be a second gold (O2, O2′), a precious metal or a precious metal alloy not containing gold.

The one or more separate materials (Md) may be a precious metal, a precious metal alloy, or a composite.

The watch component may be selected from the case, the bezel, the case back, the crown, the winding weight, or elements of a watchband such as studs, links, pins, or a clasp.

1. Process for the manufacture of a watch component based on at least a first homogeneous composite of a predetermined color, of 18 carats and more, the process comprising:
a first selection step S1 of at least a first gold in the form of a first powder, a second material in the form of a second powder and optionally one or more additional materials different from the first gold and the second material, in the form of as many corresponding additional powders,
a first mixing step S2 of the said first, second powders and, where applicable, the additional powder or powders in predetermined proportions so as to produce a first homogeneous mixed powder,
a step S4 of sintering, the sintering being a flash or SPS type sintering operated at a sintering temperature and a sintering pressure determined so that said first mixed powder does not melt, after which said first mixed powder results in said at least one first composite of color,
a step S5 of demolding the piece resulting from the sintering step S4 to obtain a demolded piece,
wherein the nature of the first gold and of the second material and of any one or more additional materials and/or the proportions of their mixture are determined so that said first mixed powder is suitable for producing a first composite of color under the conditions of the process.

2. A method according to claim 1, further comprising one or more calibration steps Se, making it possible to determine the visual characteristics of said at least one first composite as a function of its composition, so as to define the nature of the first gold and of the second material and of any one or more additional materials and the said predetermined proportions to obtain the said predetermined color (C1) on the basis of the said one or more calibration stages Se.

3. A process according to claim 1, further comprising at least one step of selecting a distinct material in the form of one or more powders, intended to be combined with said first mixed powder without mixing to it and a step S3 of placing said one or more powders of distinct materials in the mold, so as to form an assembly of at least two powders with said first mixed powder and in which said one or more powders and said first powder are not mixed with each other, where said distinct material results in a color after sintering step S4, distinct from the color of said first composite.

4. A process according to claim 1, said one or more calibration steps comprising mixing at least one gold and a second material so as to produce a mixed powder, the mixed powder being involved in a sintering step to produce a composite therefrom, the visual characteristics of said composite then being determined.

5. A process according to claim 1, said second material designating a second gold, a precious metal other than gold or a precious metal alloy not containing gold.

6. process according to claim 1, said distinct material designating a precious metal, a precious metal alloy or a mixed powder suitable for producing a composite under the conditions of said process.

7. A process according to claim 1, wherein said distinct material is a second mixed powder comprising at least one gold, said selection of one or more distinct materials includes a second selection step S1′ of a second first gold and at least one second second material in the form of a second first and at least one second second powder respectively and of one or more possible second additional materials (Mi′) in the form of as many second additional powders and at least one second mixing step S2′ of said second first and at least one second powders and, if applicable, one or more additional second powders, so as to produce at least one second mixed powder (PM2), resulting in a second composite of color, different from the color of the first composite under the conditions of the process.

8. Process according to claim 7, the color of said second composite being predetermined and the nature of the second first gold and second second materials and any additional second materials and/or the proportions of their mixture being determined on the basis of one or more calibration steps Se so as to produce said color of the second composite under the conditions of the process.

9. A process according to claim 7, said second second material being a second second gold, a precious metal other than gold or a precious metal alloy not containing gold.

10. A process according to claim 1, wherein said additional materials are selected from silver (Ag), platinum (Pt), palladium (Pd), osmium (Os), titanium (Ti), nickel (Ni), copper (Cu), aluminum (Al) and alloys thereof.

11. A process according to claim 1, in which the first mixed powder and the one or more powders of separate materials are arranged according to a predetermined positioning plan during step S3.

12. A process according to claim 1, further comprising one or more steps among a step S1a of atomizing said first gold so as to produce said first powder, a step S1b of atomization of said second material so as to produce said second powder and a step S1i of atomization of said additional materials so as to produce the corresponding powder(s), a step S1a′ of atomization of said second first gold so as to produce the second first powder, a step S1b′ of atomizing said second second material so as to produce the second second powder and a step S1i′ of atomizing any additional second materials so as to produce the powder.

13. A process according to claim 1, in which the said at least one preliminary calibration step Se allows the establishment of at least one adapted calibrating curve to determine the proportions of gold, secondary material and any additional materials and/or their mass percentage in the mixed powders, according to the color to be obtained, via extrapolation or interpolation of the parameters measured on the said at least one calibration curve and/or via a predictive computer program.

14. Watch component comprising at least one homogeneous first component, of color comprising a first gold and at least one second material as well as one or more possible additional materials, forming an indissociable and homogeneous whole, the nature of the first gold and of the second material and of any one or more additional materials and their proportions being defined so that the color corresponds to a predetermined color on at least one calibration curve, said at least one first composite forming a predetermined pattern.

15. Watch component according to claim 14, further comprising one or more distinct materials of color, in which the said at least one first composite and the one or more distinct materials remain distinct from each other, said at least one first composite having a color distinct from the color of said one or more distinct materials, such that their juxtaposition produces a predetermined visual effect.

16. Watch component according to claim 14, said at least one second material designating a second gold, a precious metal or an alloy of precious metals not containing gold.

17. Watch component according to claim 14, said one or more distinct materials (DM) designating a precious metal, a precious metal alloy or a composite.

18. Watch component according to claim 14, said at least one composite having one of the following compositions:
$$\begin{matrix}75 \% Pd 150 / 25 \% 5 N 18 \\ 50 \% Pd 150 / 50 \% 5 N 18 \\ 25 \% Pd 150 / 75 \% 5 N 18 \\ 100 \% 5 N 18\end{matrix}$$
where the term 5N refers to a 5N red gold alloy and where Pd150 refers to a 18 ct nickel-free white gold alloy.

19. Watch component according to claim 14, comprising a white gold alloy (B) of composition Au750 PdCu150, a rose gold alloy (R) of composition Au750 Ag45 Cu205 in the following proportions:
Mass % of alloys (B) and (R)

| | | | | | |
|---|---|---|---|---|---|
| Alloy B | 100 | 75 | 50 | 25 | 0 |
| Alloy R | 0 | 25 | 50 | 75 | 100 |
| Reference | A1 | A2 | A3 | A4 | A5 |

or comprising a white gold alloy of 22 carats, of composition Au925 Pd75, and a rose gold alloy of 22 carats, of composition Au917 Cu83, in a mass proportion of 67/33,
or comprising an alloy of white gold (A) of 18 carats of composition Au750 PdCu150, an alloy of rose gold (D) of 22 carats of composition Au917 Cu83 and a non-precious alloy (E) of grade 5 titanium in which the mass proportion of the alloys is determined by the following equation:
$$VmA \times \% A + VmD \times \% D + VmE \times \% E \geq 75 \%$$
where VmA, VmD and VmE refer respectively to the mass percentages of precious materials in alloys A, D and E, and where % A, % D and % E refer respectively to the mass percentages of alloys A, D and E in the piece.

20. Timepiece comprising a watch component according to claim 14.

21-28. (canceled)
